(19) United States
(12) Patent Application Publication
(10) Pub. No.: US 2024/0126740 A1
(43) Pub. Date: Apr. 18, 2024

(54) CYBER RECOVERY FORENSICS KIT - LIGHTNING RESTORE OF STORAGE SYSTEMS

(71) Applicant: Dell Products L.P., Round Rock, TX (US)

(72) Inventors: Ofir Ezrielev, Beer Sheva (IL); Jehuda Shemer, Kfar Saba (IL); Amihai Savir, Newton, MA (US)

(21) Appl. No.: 18/046,600

(22) Filed: Oct. 14, 2022

(51) Int. Cl. G06F 16/23; G06F 11/14; G06F 16/27

(52) U.S. Cl. CPC G06F 16/2329; G06F 11/1448; G06F 16/235; G06F 16/2365; G06F 16/27; G06F 2201/84

(57) ABSTRACT

One method includes receiving a request to restore data to a particular point in time, scanning a snapshot that corresponds to the point in time, based on the scanning, identifying any invalid data segments pointed to by the snapshot, for each of the invalid data segments, identifying a most recent, valid, version of that segment, and based on the request, restoring a set of valid data segments. In this method, no invalid segments are restored.

### FIELD OF THE INVENTION

Embodiments of the present invention generally relate to data protection and related processes. More particularly, at least some embodiments of the invention relate to systems, hardware, software, computer-readable media, and methods, for fast restoration of uninfected data storage systems.

### BACKGROUND

Volume or filesystem snapshots may be used to create a record of the state of the data in the volume at any given point in time. As such, a snapshot may be used to restore data as the data existed at a particular point in time by retrieving the data blocks or data segments that are pointed to by pointers in the snapshot of interest, that is, the snapshot that corresponds to that particular point in time.

However, considering snapshots only in terms of the point in time to which they correspond may result in problems. For example, when the data corresponding to a particular point in time is restored, it is possible that some of the data may be corrupted. Conventional snapshot and restore processes fail to account for this possibility. Thus, there may be a lack of awareness that the data is corrupted until after that data has already been restored. That is, no mechanism is provided, in conventional approaches, for avoiding the restoration of corrupted data.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1a discloses aspects of an example architecture according to an embodiment.

FIG. 1b discloses aspects of some example snapshots.

FIG. 2 discloses aspects of an example method according to an embodiment.

FIG. 3 discloses aspects of an example computing entity operable to perform any of the disclosed methods, processes, and operations.

### DETAILED DESCRIPTION OF SOME EXAMPLE EMBODIMENTS

Embodiments of the present invention generally relate to data protection and related processes. More particularly, at least some embodiments of the invention relate to systems, hardware, software, computer-readable media, and methods, for fast restoration of uninfected data storage systems.

In general, an embodiment of the invention may comprise a mechanism operable to prevent the restoration of corrupted data. In more detail, when a point in time (PIT), and corresponding snapshot, of interest are identified, the data segments pointed to by the pointers in that snapshot may be analyzed prior to restoration of those data segments. In cases where a data segment exhibits signs of corruption or other problems, that data segment may not be restored. Instead, the most recent, valid, version of that data segment may be restored. Thus, the restored data may constitute the most recent, and valid, version of the data and, as such, the restored data may span multiple different points in time. Further, the restored data may be devoid of any invalid segments. Finally, the invalid data segments may be backed up for later analysis to determine the cause of the problem(s) exhibited by those segments.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect is that an embodiment may avoid restoration of invalid segments. As another example, an embodiment may operate to restore the latest valid version of a dataset. An embodiment may operate to check for compatibility between/among the valid segments identified for restoration. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. ASPECTS OF AN EXAMPLE ARCHITECTURE AND ENVIRONMENT

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, data replication operations, IO replication operations, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing backup platforms, and storage environments such as the Dell PowerProtect Cyber Recovery system. In general however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM), containerized computing solutions, mobile devices, IoT (Internet of Things) systems and devices, edge devices and systems, and any other systems and devices, which may comprise hardware and/or software, that are capable of generating new and/or modified data.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, example backups in connection with which embodiments of the invention may be employed include, but are not limited to, full backups, partial backups, clones, snapshots, and incremental or differential backups.

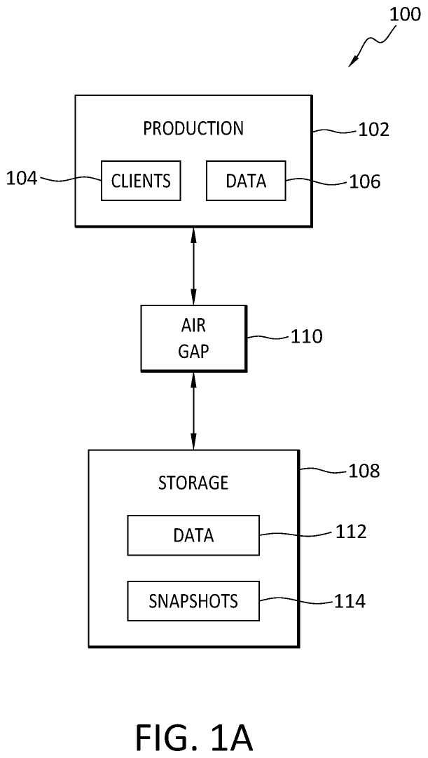

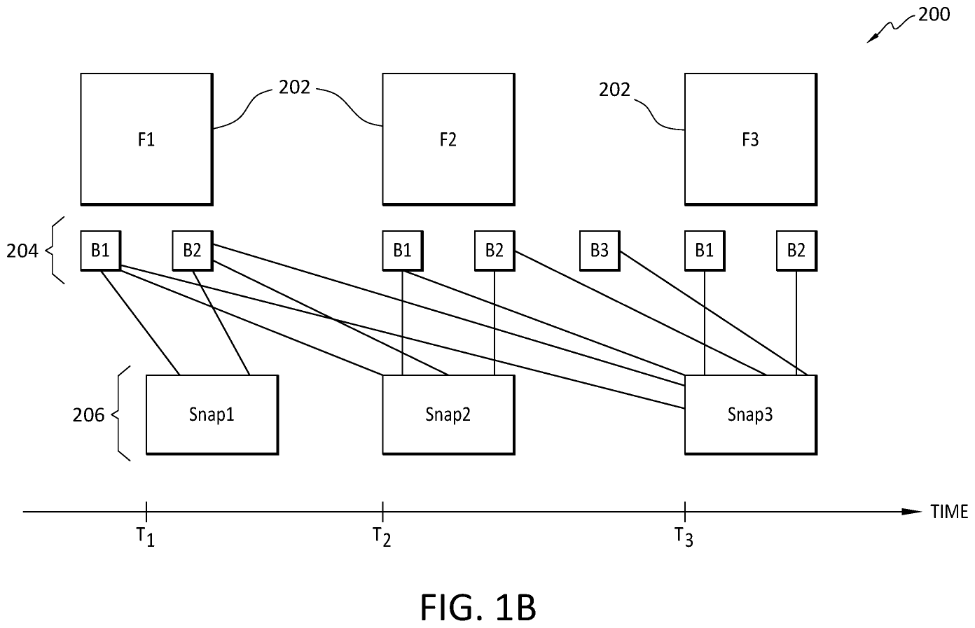

With attention now to FIG. 1a, details are provided concerning an example architecture and environment, generally denoted at 100, in connection with which some embodiments may be implemented. The information disclosed in FIG. 1a is provided only by way of illustration, and is not intended to limit the scope of the invention in any way.

As shown, a production site 102 may include various clients 104, and/or other data generators, which may be of any kind, that may carry out operations including, but not limited to, data creation, data modification, data deletion, and data replication. To this end, the production site 102 may store data 106 generated by the applications 104 until such time as that data 106 can be backed up. The data 106 may comprise, for example, one or more backup datasets, directories, and/or any other groupings of data.

With continued reference to FIG. 1a, the production site 102 may communicate, possibly on a selective basis, with data storage 108, which may comprise a data storage vault, or simply ‘vault,’ by way of an air gap 110. Note that as used herein, an ‘air gap’ embraces a physical isolation, or separation, of a storage vault from any exterior system or device that may be susceptible to attack. That is, when the air gap associated with a vault is open, the air gapped vault is physically detached, and unconnected, from such exterior devices. As such, when the air gap is open, the air gapped vault is not accessible by any form of wireless, or hardwire, including optical, communication system or device. Conversely, when the air gap is closed, the vault, and some or all of its contents, may be accessible by external systems and devices, such as an application host for example, whether by wireless and/or hardwired communication channels.

In some embodiments, the data storage 108 may comprise a Dell PowerProtect Cyber Recovery vault, but no particular vault is required. The data storage 108 and part, or all, of its contents, may be isolated from the production site 102, and other external entities, when the air gap 110 is open. When the air gap 110 is closed, the data storage 108 may be able to communicate with the production site 102 to transfer data, information, and metadata, for example, in either or both directions, between the data storage 108 and production site 102, as shown in FIG. 1a. In one embodiment, the air gap 110 may be omitted and the production site 102 may directly communicate with the data storage 108.

As further indicated in FIG. 1a, the data storage 108 may store data 112, such as may be received from the production site 102. The data storage 108 may also comprise one or more snapshots 114 of the data 112. In an embodiment, the snapshots 114 may additionally, or alternatively, be stored at the production site 102.

With reference next to FIG. 1b, details are provided concerning some aspects of snapshots such as may be employed in some embodiments. In the schematic 200 of FIG. 1b, various new/modified files 202 are shown as written to storage. As indicated by the timeline, the files 202 are written at different respective times. Each of the files 202 comprises a respective set 204 of data blocks, one or more of which may comprise new/modified data blocks. Various snapshots 206 may be taken to capture the state of the data at particular times, such as times T1 (Snap1), T2 (Snap2), and T3 (Snap3).

In general, a snapshot 206 may comprise a group of pointers, each of which points to a particular portion of data, such as a block or segment for example. Pointers may be copied from one snapshot to the next, and snapshots 206 may be taken at any point in time (PIT) of interest. To restore a particular grouping of data, such as a file, directory, file system, or other grouping, the snapshot corresponding to the PIT of interest can be read, and the blocks that are pointed to by the pointers in that snapshot may then be retrieved. Further details concerning snapshot related operations of some example embodiments are disclosed elsewhere herein.

With reference to the illustrative example of FIG. 1b, because only file F1 202 exists at time T1, Snap1 206, taken at time T1, only comprises pointers to the blocks 204 of file F1202. However, after Snap1206 has been taken, a new file F2 202, including two blocks 204, has been added. Thus, Snap2 206, taken at time T2, includes pointers to the blocks 204 of file F1 202, and also includes pointers to blocks B1 204 and B2 204 of file F2 202. At some point after Snap2 206 has been taken, a new/modified block B3 204 is added to the file F2 202. As such, Snap2 206 does not include a pointer to that new/modified block B3 204. However, Snap3 206, taken after the new/modified block B3 204 is added to the file F2 202, includes a pointer to that new/modified block B3 204, as well as pointers to the blocks 204 of file F1 202, and pointers to the blocks 204 of newly added file F3 202.

### B. OPERATIONAL ASPECTS OF AN EMBODIMENT

In general, an embodiment may involve creating a snapshot of stored data as the data existed at a specified PIT, and then using the snapshot to later restore the data that is pointed to by the pointers in the snapshot. An embodiment may comprise an additional layer of usage and complexity by analyzing the segments pointed to by the pointers in order to identify the latest, uncorrupted, version of each segment. For example, the snapshot to be used for a restore process may be scanned, and any invalid segments pointed to by respective pointers in the snapshot, identified.

In an embodiment, any corrupted segments identified during the snapshot scan may not be restored. Rather, the most recent valid version of such corrupted segments may be restored instead. An embodiment may, after having identified the most recent, valid, version of each segment, and prior to restoration of the data, then check for compatibility between the segments that are to be restored. In another embodiment, this compatibility check may, alternatively, be performed after the most recent valid versions of each segment have been restored.

In more detail, data segments may be incompatible with each other for various reasons. For example, the structure of two data segments may differ such that when a dataset, such as a file for example, is restored that includes the two segments, the file cannot be read. As another example, the content of two data segments may differ such that a similar result occurs. In a final example, if two data segments are generated by different respective versions of an application, the two data segments may not be compatible with each other. Thus, an aim of a compatibility check according to an embodiment is to restore a grouping of data, comprising segments that are compatible with each other, and which supports any operations that may be needed to be performed with respect to that data.

In an embodiment, the compatibility check between/among the segments that have been restored, or are to be restored, may be performed automatically. Further, the compatibility check may be performed in any of a variety of ways.

For example, if the data segments are elements of an application that has been restored, the compatibility check may comprise an attempt to run the application. If the application runs successfully, the data segments may be deemed to be compatible with other, and if not, the data segments may be deemed to be incompatible with each other. In the latter case, the data may be rolled back to the state it was in before the restore was performed, and a different, possibly earlier, PIT may then be chosen from which to restore the data.

In another example of a data segment compatibility check, a machine learning (ML) model may be used to examine the data segments that have been restored, or are to be restored. The ML model may be programmed to draw inferences, based on the examination, as to whether or not the data segments are compatible with each other. If the ML model determines that data segments are incompatible with each other, the system may choose a different, and possibly earlier, PIT from which to restore the data.

As will be apparent from this disclosure, an embodiment may provide for fast restoration of storage system data by switching pointers to a PIT of interest, and analyzing segments to see if they were corrupted, choose the most recent uncorrupted ones, and instantly roll back to a different PIT in case an incompatibility with other segments is found. Advantageously, such an embodiment may provide for increased speed of restore for storage systems, and for the restoration of the most recent valid, and compatible, data.

### C. EXAMPLE METHODS

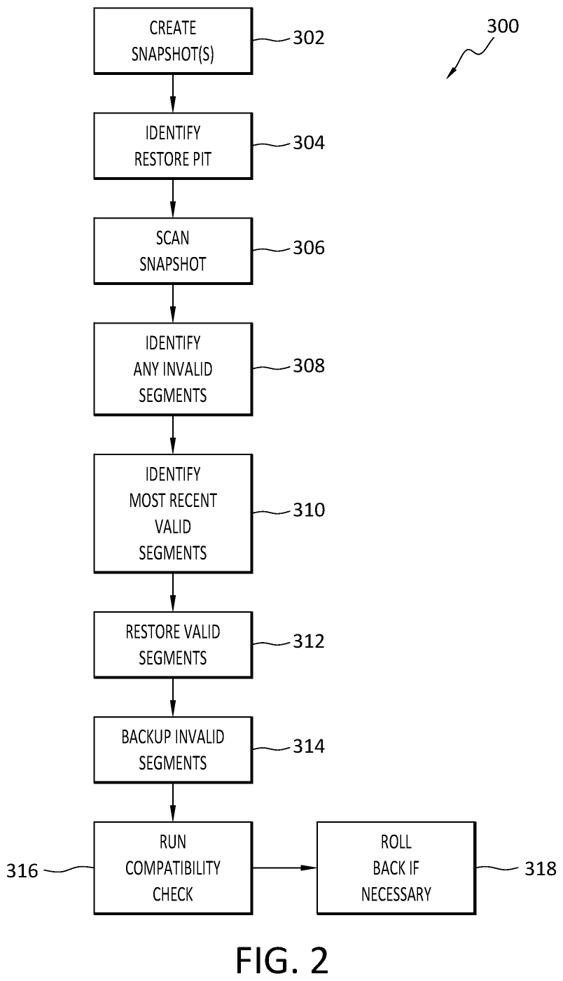

It is noted with respect to the disclosed methods, including the example method of FIG. 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 2, a method according to one example embodiment is denoted generally at 300. The method 300 may be performed in whole or in part, by/at a data storage site, or the method 300 may be performed at a production site. In an embodiment, the method 300 may be cooperatively performed by a production site and a data storage site.

The method 300 may begin with the creation of one or more snapshots 302. The snapshots may be created 302, for example, by a backup application and/or backup server, which may be elements of a data storage site. In one embodiment, the snapshots that have been created 302 may be stored at a production site and/or at a data storage site.

At some point after creation of the snapshots 302, a restore PIT may be identified 304. For example, a data storage site may receive, from a production site and/or another entity, a request to restore stored data to a particular PIT. Once the restore PIT has been identified 304, the snapshot corresponding to that PIT may be retrieved and scanned 306.

The scan 306 of the snapshot may serve to identify 308 any invalid data segments, or other portions of data, that are pointed to by respective pointers of the snapshot. As used herein, ‘invalid’ segments may include, but are not limited to, corrupted data segments.

If any invalid data segments are identified 308, the method 300 may then identify 310 the most recent, valid, version of the corrupted data segments. This operation 310 may involve examining one or more of the snapshots that were created prior in time to the snapshot upon which the restore operate was based.

Once a set of valid data segments has been identified 310, the set of valid data segments may then be restored 312. In an embodiment, the restored set of valid segments comprises only valid segments, and no invalid segments. Note that if any invalid data segments are identified 308, the set of valid data segments ultimately restored may span more than one PIT, since one or more of the valid data segments may be pointed to by a pointer in a different, or prior, snapshot than the snapshot upon which the restore operation was based 304.

In one embodiment, a dataset that includes one or more invalid segments may be backed up 314 for further analysis. For example, that dataset may be examined to determine the cause of the invalid data segments.

Finally, after the set of valid data segments has been restored 312, those data segments may be checked 316 for compatibility with each other. In an embodiment, any incompatibilities may be resolved by rolling 318 the restored set of data segments back to an earlier PIT until a valid, and compatible, set of data segments is identified.

### D. FURTHER EXAMPLE EMBODIMENTS

Following are some further example embodiments of the invention. These are presented only by way of example and are not intended to limit the scope of the invention in any way.

Embodiment 1. A method, comprising: receiving a request to restore data to a particular point in time; scanning a snapshot that corresponds to the point in time; based on the scanning, identifying any invalid data segments pointed to by the snapshot; for each of the invalid data segments, identifying a most recent, valid, version of that segment; and based on the request, restoring a set of valid data segments.

Embodiment 2. The method as recited in embodiment 1, wherein no invalid data segments are restored.

Embodiment 3. The method as recited in any of embodiments 1-2, wherein the restored set of valid data segments spans multiple points in time, one of which is the particular point in time.

Embodiment 4. The method as recited in any of embodiments 1-3, wherein after the set of valid data segments is restored, the restored set of valid data segments is subjected to a compatibility check to determine whether the restored valid data segments are compatible with each other.

Embodiment 5. The method as recited in any of embodiments 1-4, wherein any invalid data segments discovered during the scanning are backed up.

Embodiment 6. The method as recited in any of embodiments 1-5, wherein when any incompatible data segments are discovered in the restored set of valid data segments, the restored set of valid data segments is rolled back to a most recent point in time at which all of the valid data segments are compatible with each other.

Embodiment 7. The method as recited in any of embodiments 1-6, wherein the restored set of valid data segments is an element of an application, and after the set of valid data segments is restored, an attempt is made to run the application to ensure compatibility of the restored valid data segments with each other.

Embodiment 8. The method as recited in any of embodiments 1-7, wherein one or more of the invalid data segments are corrupted.

Embodiment 9. The method as recited in any of embodiments 1-8, wherein the request is received by an air gapped data storage vault.

Embodiment 10. The method as recited in any of embodiments 1-9, wherein the invalid data segments are analyzed to determine a cause for their lack of validity.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

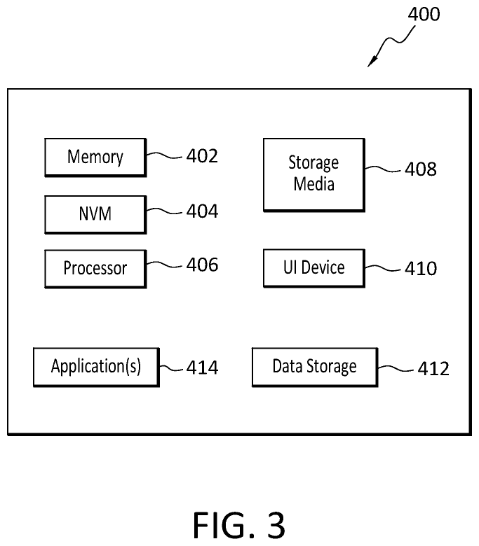

With reference briefly now to FIG. 3, any one or more of the entities disclosed, or implied, by FIGS. 1-2 and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 3.

In the example of FIG. 3, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI (user interface) device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, comprising:
receiving a request to restore data to a first point in time;
scanning a snapshot that corresponds to the first point in time;
based on the scanning, identifying any invalid data segments pointed to by the snapshot;
for each of the invalid data segments, identifying a most recent and valid version of that segment that existed at a second point in time that is prior to the first point in time;
based on the request, restoring a set of valid data segments based on the most recent and valid version; and
running a compatibility check to determine whether the restored valid data segments are compatible with each other.

2. The method as recited in claim 1, wherein no invalid data segments are restored.

3. The method as recited in claim 1, wherein the restored set of valid data segments spans multiple points in time, a latest of which is the first point in time.

4. (canceled)

5. The method as recited in claim 1, wherein any invalid data segments discovered during the scanning are backed up.

6. The method as recited in claim 1, wherein when any incompatible data segments are discovered in the restored set of valid data segments, the restored set of valid data segments is rolled back to a most recent point in time at which all of the valid data segments are compatible with each other.

7. The method as recited in claim 1, wherein the restored set of valid data segments is an element of an application, and after the set of valid data segments is restored, an attempt is made to run the application to ensure compatibility of the restored valid data segments with each other.

8. The method as recited in claim 1, wherein one or more of the invalid data segments are corrupted.

9. The method as recited in claim 1, wherein the request is received by an air gapped data storage vault.

10. The method as recited in claim 1, wherein the invalid data segments are analyzed to determine a cause for their lack of validity.

11. A non-transitory storage medium having stored therein instructions that are executable by one or more hardware processors to perform operations comprising:
receiving a request to restore data to a first point in time;
scanning a snapshot that corresponds to the first point in time;
based on the scanning, identifying any invalid data segments pointed to by the snapshot;
for each of the invalid data segments, identifying a most recent and valid version of that segment that existed at a second point in time that is prior to the first point in time;
based on the request, restoring a set of valid data segments based on the most recent valid version; and
running a compatibility check to determine whether the restored valid data segments are compatible with each other.

12. The non-transitory storage medium as recited in claim 11, wherein no invalid data segments are restored.

13. The non-transitory storage medium as recited in claim 11, wherein the restored set of valid data segments spans multiple points in time, a latest of which is the first point in time.

14. (canceled)

15. The non-transitory storage medium as recited in claim 11, wherein any invalid data segments discovered during the scanning are backed up.

16. The non-transitory storage medium as recited in claim 11, wherein when any incompatible data segments are discovered in the restored set of valid data segments, the restored set of valid data segments is rolled back to a most recent point in time at which all of the valid data segments are compatible with each other.

17. The non-transitory storage medium as recited in claim 11, wherein the restored set of valid data segments is an element of an application, and after the set of valid data segments is restored, an attempt is made to run the application to ensure compatibility of the restored valid data segments with each other.

18. The non-transitory storage medium as recited in claim 11, wherein one or more of the invalid data segments are corrupted.

19. The non-transitory storage medium as recited in claim 11, wherein the request is received by an air gapped data storage vault.

20. The non-transitory storage medium as recited in claim 11, wherein the invalid data segments are analyzed to determine a cause for their lack of validity.
